(19) United States
(12) Patent Application Publication
(10) Pub. No.: US 2008/0209198 A1
(43) Pub. Date: Aug. 28, 2008

(54) Boot Acceleration For Computer Systems

(76) Inventors: Timothy W. Majni, The Woodlands, TX (US); Mark J. Thompson, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/678,926

(22) Filed: Feb. 26, 2007

(51) Int. Cl. G06F 9/00

(52) U.S. Cl. 713/2

(57) ABSTRACT

Boot acceleration for computer systems is disclosed. In an exemplary embodiment, a method of boot acceleration for a computer system may comprise monitoring data requests during a boot procedure. The method may also comprise pre-fetching data from a storage device during a subsequent boot procedure based at least in part on the monitored data requests. The method may also comprise accessing the pre-fetched data from a cache to accelerate the subsequent boot procedure.

### BACKGROUND

Each time a computer system is started, various initialization procedures and tests are performed before the computer system is ready to run the operating system and application software. These initialization procedures and tests are typically referred to as the boot sequence. An exemplary boot sequence may include executing a power-on self-test program (POST), followed by execution of the basic input output system (BIOS). The BIOS points to a boot section on disk and initializes code to read the master boot record and load the operating system (OS). After the OS initializes, applications can run on the computer system.

Boot time is dependent at least to some extent on reading initialization and runtime code/data from disk drives. When the computer system is started, restarted or reset, the computer system has to run all of the initialization procedures, perform all of the tests, and read initialization and runtime code/data from the disk drives, thereby reducing productivity while the user waits. If the computer system is a network server, all users on the network needing access to the server must wait for the computer system to reboot.

### BRIEF DESCRIPTION OF THE DRAWINGS

FIG. 1 is a high-level schematic illustration of an exemplary computer system which may implement boot acceleration.

FIG. 2 is a high-level schematic illustration of exemplary interfaces for a computer system implementing boot acceleration.

FIG. 3 is a flowchart illustrating exemplary operations to implement boot acceleration for a computer system.

### DETAILED DESCRIPTION

Briefly, systems and methods described herein may be used to implement boot acceleration in a computer system. In an exemplary embodiment, disk controller firmware generates a list of disk locations accessed during the boot procedure (also referred to as “hints”). Additional hints may also be provided by device drivers resident in the operating system (OS), as well as OS services through the device driver interface. Some or all of these hints may be used on a subsequent boot procedure to pre-fetch data from the disk driver and put the data into a cache to better optimize data access and accelerate the boot procedure.

### Exemplary System

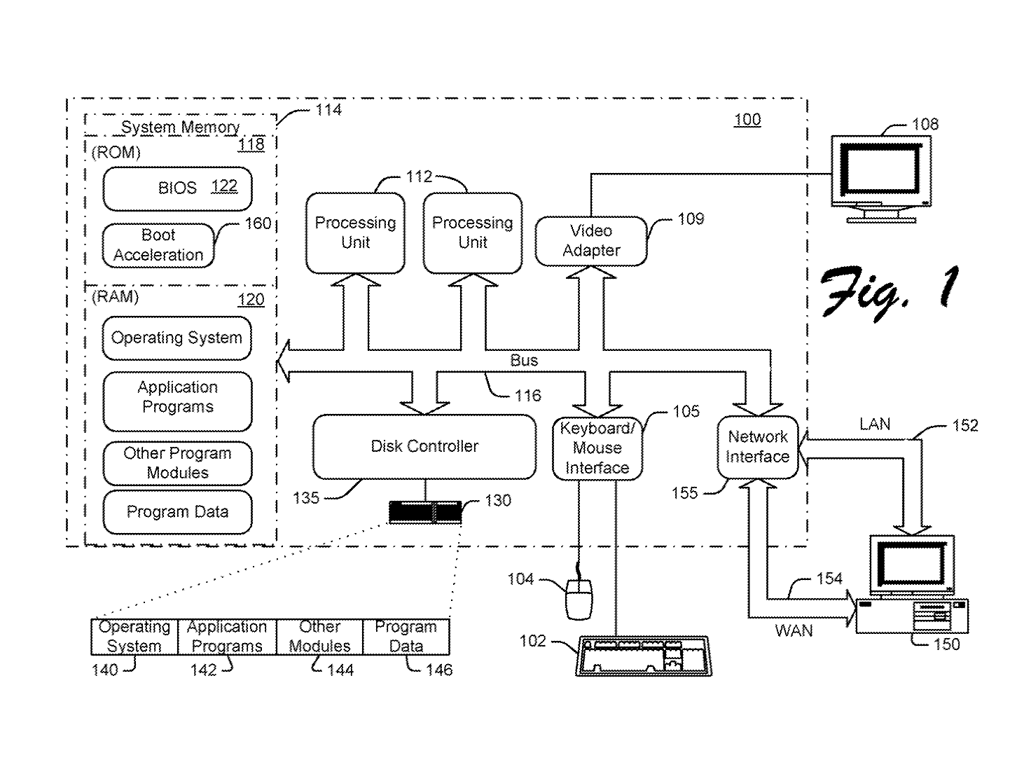

FIG. 1 is a high-level schematic illustration of an exemplary computer system which may implement boot acceleration. For purposes of illustration, computer system 100 is an Intel Processor Family (IPF)-based, Symmetric Multi-Processing (SMP) server computer. However, it is noted that exemplary computer system 100 is shown for purposes of illustration and is not intended to be limiting. Other suitable computer systems may include personal computers (PCs) or laptop computers, network workstation, appliances, or other computing devices.

Exemplary computer system 100 includes one or more processors or processing units 112, a system memory 114, and a bus 116 that couples various system components includes the system memory 114 to processors 112. The processing unit(s) 112 may be partitioned in exemplary embodiments.

Various processor architectures are known in the art, such as the PA-RISC family of processors developed by Hewlett-Packard Company (“HP”), Intel Corporation's (“Intel”) architecture (“IA”) processors (e.g., the well-known IA-32 and IA-64 processors), and the like. The IA-64 is a 64-bit processor architecture co-developed by HP and Intel, which is based on Explicitly Parallel Instruction Computing (EPIC).

The bus 116 represents one or more of any of several types of bus structures, including a memory bus or memory controller, a peripheral bus, an accelerated graphics port, and a processor or local bus using any of a variety of bus architectures. The system memory 114 includes read only memory (ROM) 118 and random access memory (RAM) 120. A basic input/output system (BIOS) 122, containing the basic routines that help to transfer information between elements within computer system 100, such as during start-up or reboot, is stored in ROM 118.

Computer system 100 further includes one or more storage device such as hard disk drive 130 for reading from and writing data. The hard disk drive 130 interfaces with various system components via the bus 116 and disk controller 135. The hard disk drive 130 and associated computer-readable media provide nonvolatile storage of computer-readable instructions, data structures, program modules and other data for computer system 100. A number of program modules may be stored on the hard disk driver 130, including an operating system 140, one or more application programs 142, other program modules 144, and program data 146.

Although the exemplary environment described herein only shows a hard disk drive 130, other types of computer-readable media such as magnetic cassettes, flash memory cards, digital video disks (DVDs), random access memories (RAMs), read only memories (ROMs), and the like, may also be used in the exemplary computer system 100.

A user may enter commands and information into computer system 100 through input devices such as a keyboard 102 and a pointing device 104. For example, the user may use these input devices to configure boot acceleration options from a user interface (not shown). These and other input devices (not shown) are connected to the processing unit(s) 112 through an interface 105 that is coupled to the bus 116. A monitor 108 or other type of display device may also be connected to the bus 116 via an interface, such as video adapter 109.

Computer system 100 may operate in a networked environment using logical connections to one or more remote computers, such as a remote computer 150. The remote computer 150 may be a personal computer, a server computer, a router, a network PC, a peer device or other common network node, and typically includes many or all of the elements described for computer system 100. The logical connections depicted include a local area network (LAN) 152 and a wide area network (WAN) 154 connected to the computer system 100 via a network interface 155.

Generally, the data processors of computer system 100 are programmed by means of instructions stored at different times in the various computer-readable storage media of the computer. Programs and operating system may be distributed, for example, on floppy disks, CD-ROMs, or electronically, and are installed or loaded into the secondary memory of a computer. At execution, the programs are loaded at least partially into the computer's RAM 120.

Prior to executing programs, however, various initialization procedures and tests (known as the boot sequence or boot procedure) are performed for the computer system 100. According to exemplary embodiments, the computer system 100 may implement a boot acceleration procedure 160 (e.g., firmware residing in ROM 118 for access by the disk controller 135.). Boot acceleration procedure 160 generates hints during at least some of the initialization procedures and tests and then implements the hints to move data contained on a storage device (e.g., hard disk drive 130) into a cache (e.g., RAM 120) and thereby load the OS 140 faster than if the data had to be directly accessed from the storage device itself.

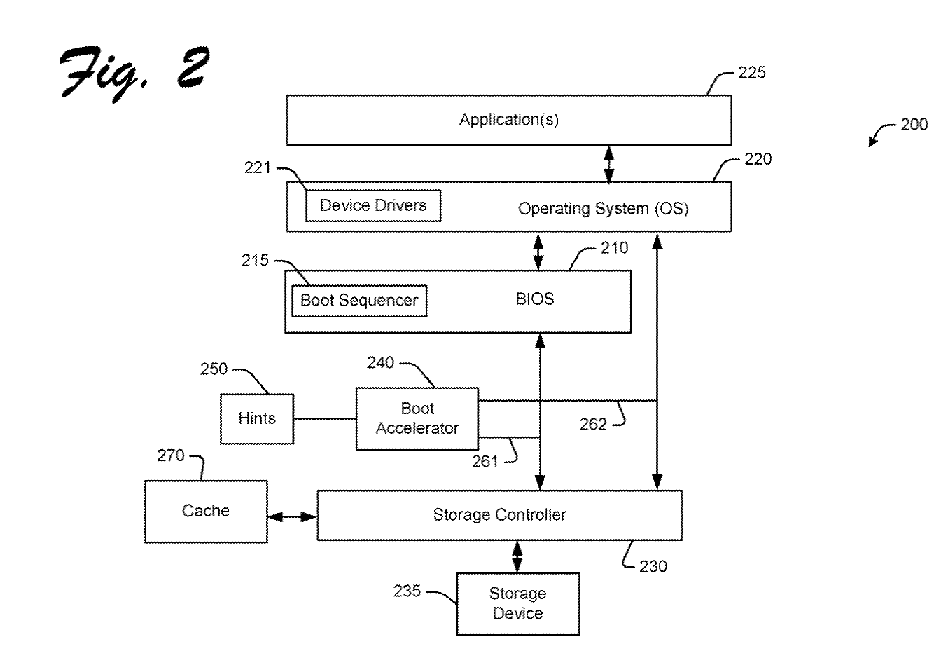

FIG. 2 is a high-level schematic illustration of exemplary interfaces 200 for a computer system implementing boot acceleration (e.g., the computer system 100 shown in FIG. 1). The blocks represent hardware/software/firmware components. The arrows between these various components illustrate types of permitted interactions. Each of the components interacts collaboratively within this framework via defined interfaces to achieve the overall system function.

The BIOS 210 is responsible for handling rset and power-on events, hardware discovery and initialization, hardware description, system software loading and launching, and hardware dependent functions. Boot sequencer 215 may be called by the BIOS 210 to implement a boot procedure.

For purposes of implementing the boot accelerator, the “boot procedure” is defined as the time between the system being lifted out of reset until one of several conditions is met: 1) a pre-determined number of blocks are read from the storage device 235, 2) notification from a device driver 221, or 3) controller cache 270 is filled.

During the boot procedure, there are some sanity checks (e.g., POST) that are performed. After those checks have passed, then power and clocks are provided to the processor, which gets control of the system and begins execution of the other firmware. After initializing the processor(s), the hardware present on the computer platform is discovered and initialized for the OS 220.

After the hardware is initialized and functional, firmware is copied into the main memory (e.g., RAM 120 in FIG. 1) to activate boot devices (e.g., the storage controller 230 and storage device 235). The firmware reads the boot devices, loads a program (e.g., an OS loader) into memory, and then passes it control of computer system by branching one of the processors (typically called the boot startup processor) into the entry point of such OS loader program. The OS loader program uses standard firmware interfaces to discover and further initialize the computer system, and then branch into the operating system code. Of course, the boot procedure may terminate prior to this for purposes of generating hints for boot acceleration if one of the conditions above is satisfied (e.g., controller cache 270 is filled).

In an exemplary embodiment, a boot accelerator 240 may be implemented during the boot procedure to accelerate subsequent boot procedures. Boot accelerator 240 may be implemented as program code (e.g., firmware) operatively associated with the storage controller 230. Although the boot accelerator 240 is shown as a separate component from the storage controller 230 in FIG. 2, it is noted that the boot accelerator 240 may be included as part of the storage controller firmware, stored in memory on the storage controller, and executed by the storage controller's microprocessor. According to such an embodiment, no additional hardware is required by the computer system to implement boot acceleration.

The boot accelerator 240 monitors (as illustrated by lines 261 and 262) read and/or write requests to the storage device 235 via the storage controller 230, and generates hints 250. The hints 250 may be generated by monitoring read and/or write requests during the boot procedure, e.g., from the BIOS 210, the OS 220, device drivers 221 resident in the OS 220. The hints 250 may include the identity of data blocks being read and/or written, corresponding boot event(s), and/or other data. In an exemplary embodiment, the hints 250 may be compiled as a list of hints and stored in non-volatile memory.

When the computer system is reset or restarted, the boot procedure may again be performed. During this subsequent boot procedure, the hints 250 may be used by the boot accelerator 240 to pre-fetch data from the storage device 235 and store the pre-fetched data in a cache 270. Accordingly, the data needed during the subsequent boot procedure (identified during the previous boot procedure and stored as hints) can be more quickly accessed from the cache 170 than it would take for the storage controller 230 to access this same data from the storage device 235.

For each subsequent boot procedure, the boot accelerator 240 may monitor requests to storage controller 230. Accordingly, boot acceleration is adaptive. That is, the hints 250 may be continually updated with each reboot to add new hints and remove old hints. It is noted that every (or at least some) boot sequence may be used to refine the list of blocks to be pre-read. Blocks that are not used are discarded from the list, and new blocks which are read or written are added. For example, the operating system may offer hints of blocks to pre-read during the next boot sequence; services may provide hints of blocks to be pre-read to speed general system initialization; and applications may provide hints of blocks to be pre-read to speed general system initialization. Other examples are also contemplated for determining which hints to replace and/or when to replace these hints.

Optionally, the hints 250 (or list of hints) may be ordered or include sequence data so that the pre-fetched data can be stored in a predetermined order in the cache 270 for faster access. Also optionally, the hints 250 (or list of hints) may be updated by the OS 220, device drivers 221, and/or applications 225. For example, the hints 250 may be updated with a new location for data that is to be pre-fetched during a subsequent boot operation if this data is moved during disk defragmentation. These updates may be given priority during subsequent boot.

It should be readily appreciated that by monitoring data access requests to the storage controller, boot acceleration is not dependent on input from the OS 220, and therefore may be implemented regardless of the OS being used. In addition, by monitoring data access requests to the storage controller, the hints 250 may even include requests for data which is hidden from the OS 220.

Before continuing, it is noted that the exemplary embodiments discussed above are provided for purposes of illustration. Other system implementations are also contemplated.

### Exemplary Operations

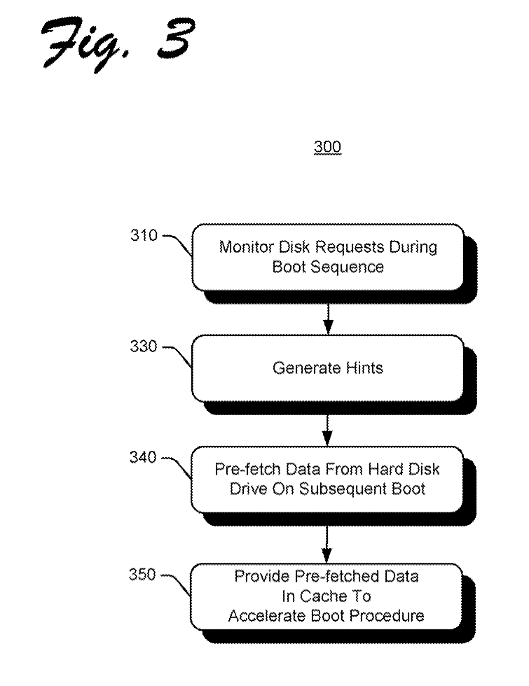

FIG. 3 is a flowchart illustrating exemplary operations 300 to implement boot acceleration for a computer system. The operations may be embodied as logic instructions on one or more computer-readable media. When executed on a processor, the logic instructions cause a general purpose computing device to be programmed as a special-purpose machine that implements the described operations. In an exemplary implementation, the components and connections depicted in the figures may be used to implement boot acceleration for computer systems.

In operation 310 the computer system initiates a boot procedure and disk requests are monitored during the boot sequence. For example, the disk controller may monitor read and/or write requests on the hard disk drive(s). In operation 320, hints may be generated. Hints may include a list of disk locations accessed during the boot procedure (e.g., from operation 310). Optionally, other information may also be received from the OS and/or one or more device drivers resident in the OS.

On a subsequent boot, the cache may be freed (e.g., by clearing memory allocations) and I/O hardware reset. In operation 340, data may be pre-fetched from the hard disk drive in advance of being needed. In operation 350, pre-fetched data is available in cache to accelerate the boot procedure. During the boot procedure, the firmware adapters are reset and the OS is loaded into memory. The OS and corresponding application software then controls all of the processors.

Other exemplary operations may include, but are not limited to, identifying data access requests as read and/or write requests during the boot procedure (e.g., during operation 310). This information (whether the data access requests is a read or write request) may be used, for example, to update parity data in RAID storage systems and thereby accelerate write operations from the system log file. That is, additional data blocks may be pre-read for RAID storage parity calculations to accelerate anticipated operating system write operations.

The operations shown and described herein are provided to illustrate exemplary implementations of boot acceleration for computer systems and are not intended to be limiting. For example, a different boot sequence may be implemented and the corresponding boot acceleration operations. Other operations may also vary based at least in part on design considerations.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims.

1. A computer system with boot acceleration, comprising:
at least one storage device having a disk controller;
a boot acceleration procedure called during a boot procedure to monitor the disk controller for data requests during the boot procedure; and
a cache for accessing pre-fetched data from the storage device during a subsequent boot procedure based at least in part on the monitored data requests.

2. The computer system of claim 1 further comprising a list of hints including information identified by monitoring the disk controller during at least one boot procedure.

3. The computer system of claim 1 further comprising a list of hints including information received from a system BIOS during at least one boot procedure.

4. The computer system of claim 1 further comprising a list of hints including information received from an operating system (OS) during at least one boot procedure.

5. The computer system of claim 4 further comprising a list of hints including information received from device drivers resident in the OS during at least one boot procedure.

6. The computer system of claim 1 further comprising an adaptive list of hints.

7. The computer system of claim 1 wherein the pre-fetched data is accessed from the cache without having to access the at least one storage device when the pre-fetched data is needed during the subsequent boot procedure.

8. The computer system of claim 1 further comprising RAID storage updated based at least in part on the monitored data requests.

9. The method of boot acceleration for a computer system, comprising:
monitoring data requests during a boot procedure;
pre-fetching data from a storage device during a subsequent boot procedure based at least in part on the monitored data requests; and
accessing the pre-fetched data from a cache to accelerate the subsequent boot procedure.

10. The method of claim 9 wherein pre-fetching data from the storage device is based on a list of hints.

11. The method of claim 10 further comprising updating the list of hints with each subsequent boot.

12. The method of claim 10 further comprising updating the list of hints by the operating system after the boot procedure.

13. The method of claim 9 further comprising storing the pre-fetched data in the cache before the pre-fetched data is needed during the subsequent boot procedure.

14. The method of claim 9 wherein the pre-fetched data is accessed from the cache without having to access the storage device when the pre-fetched data is needed during the subsequent boot procedure.

15. The method of claim 9 wherein monitoring data requests includes identifying disk blocks on the storage device.

16. The method of claim 15 wherein monitoring data requests includes identifying boot events corresponding to the identified disk blocks on the storage device.

17. The method of claim 9 wherein monitoring data requests includes identifying data access requests on the storage device as read or write.

18. The method of claim 17 further comprising pre-reading additional data blocks for RAID storage parity calculations to accelerate anticipated operating system write operations.

19. The method of claim 9 wherein pre-fetching data includes sequencing data access requests to reduce data access time on the storage device.

20. A computer system for accelerating a boot procedure, comprising:
means for identifying data to pre-fetch from a hard disk drive during a boot procedure;
means for pre-fetching the data from the hard disk drive during a subsequent boot procedure; and
means for accessing the pre-fetched data without having to access the hard disk drive when the pre-fetched data is needed during the subsequent boot procedure.

21. The computer system of claim 20 further comprising sequencing means for pre-fetching data from the hard disk drive to reduce data access time.

22. The computer system of claim 20 further comprising means for accelerating anticipated operating system write operations for RAID storage.
